(19) United States
(12) Patent Application Publication
(10) Pub. No.: US 2006/0033398 A1
(43) Pub. Date: Feb. 16, 2006

(54) Drum commutator for an electric machine

(76) Inventor: Joze Potocnik, Idrija (SI)

Correspondence Address: KATTEN MUCHIN ROSENMAN LLP, 575 MADISON AVENUE, NEW YORK, NY, 10022-2585, US

(21) Appl. No.: 11/042,952

(22) Filed: Jan. 24, 2005

Related U.S. Application Data
(63) Continuation of application No. PCT/EP03/07813, filed on Jul. 18, 2003.

(30) Foreign Application Priority Data
Jul. 24, 2002 (DE) 102 33 712.8

(51) Int. Cl. H01R 39/04; H02K 13/04

(52) U.S. Cl. 310/236; 310/233

(57) ABSTRACT

A drum commutator for an electric machine includes a sleeve-shaped support element made of an insulating pressing material, a plurality of metallic conductor segments which are evenly arranged around the support element, and an interference suppression disk which is connected in an electrically conducting manner to the conductor segments in the area of the ends lying opposite the connecting lugs. The conductor segments have resilient contact tongues at the ends that are opposite the connecting lugs. Assigned points of contact of the contact tongues, which are located at a distance from the base, are directly connected to the interference suppression disk. The resilient contact tongues are separated from the adjacent parts of the drum commutator in the area between the base and the point of contact such that the position of the contact tongues relative to the adjacent parts can be modified due to thermal expansion in said area.

The present invention relates to a drum commutator for an electric machine, comprising a sleeve-like support member made from insulating molding compound, a plurality of metal conductor segments disposed thereon in evenly spaced manner around the commutator axis, with terminal lugs disposed thereon at the ends, and an annular interference-suppression disk, which is connected in electrically conductive manner to the conductor segments in the region of the ends opposite the terminal lugs.

Drum commutators, also known as cylindrical commutators, are known in diverse configurations. To an increasing extent, drum commutators are being equipped with spark-suppression devices, in order to prevent impairment of nearby electronic assemblies. Such interference-suppression devices can be designed in particular as annular elements, which are made of a material having voltage-dependent resistance and which are connected in electrically conductive manner to the conductor segments.

As regards the arrangement of those annular elements on the drum commutator, two fundamental designs can be distinguished from one another, on the one hand interference-suppression rings mounted radially outward of the brush running surface (for example, see U.S. Pat. No. 5,895,990 A, U.S. Pat. No. 5,717,270 A, GB 2183933 A and U.S. Pat. No. 5,796,203 A), and on the other hand interference-suppression rings mounted radially inward of the brush running surface (for example, see U.S. Pat. No. 6,285,106 B1 and DE 19953231 A1). Also known are special forms of interference-suppressed drum commutators, in which the conductor segments are disposed on the outside of cylindrical interference-suppression elements (see DE 2055648 and DE 3614869 C2). Finally, EP 364292 B1 describes a drum commutator with a support member made of thermoplastic material, in which a heat-resistant reinforcing ring is provided radially underneath the terminal lug, which ring is provided with an interference-suppressing coating or can be disposed adjacent to a separate interference-suppression ring; in common with the separate interference-suppression ring that may be provided in addition, this reinforcing ring is mounted on a seat of the support member, where it is retained by straps protruding from the conductor segments.

In drum commutators with interference-suppression rings disposed outward of the brush running surface, it is a disadvantage that manufacture cannot be automated or at best can be automated only by accepting quality losses. Otherwise, for many practical applications, only drum commutators with interference-suppression rings disposed radially inward of the brush running surface can be considered, because of the limitation on the space available for the respective commutator.

A problem of such drum commutators with interference-suppression rings disposed radially inward of the brush running surface results from the different thermal expansion behavior of the interference-suppression ring, which is usually made of ceramic material, compared with the other components of the commutators in question. Specifically, if the thermal stresses are large enough, they can cause premature failure of commutators due to broken interference-suppression disks and/or destroyed connections between the conductor segments and the interference-suppression disks, unless special precautions are taken. As a solution to this problem, it is proposed in DE 19953231 A1 that the interference-suppression disk be joined to the support member by means of an elastic adhesive and that the conductor segments be connected to the interference-suppression disk via thin wires, which are soldered on the one hand to the terminal lug of the associated conductor segment and on the other hand to an associated metallization zone of the interference-suppression disk. In contrast, according to U.S. Pat. No. 6,285,106 B1, which discloses a drum commutator of the class in question, there are provided, for electrical contact between the conductor segments and the interference-suppression disks, leaf springs that are disposed inside an annular cavity, which is bounded by the support member, the conductor segments and an annular cover, and in which the interference-suppression disk is also housed. The leaf springs, which permit different radial thermal insulation of the interference-suppression disk on the one hand and of the other commutator components on the other hand, can be fixed in particular to the annular cover.

A particular disadvantage of the two known drum commutators, evaluated in the foregoing, each with an interference-suppression disk disposed radially inward of the conductor segments, is in particular the high expense of manufacture, which hampers the competitiveness of the drum commutators in question. Particularly in the case of the commutator according to EP 364292 B1, this high expense is due largely to the great number of components to be joined together. In the drum commutator according to EP 364292 B1, a further disadvantage is that the contacting resulting alone from the bearing force of the leaf springs on the conductor segments and on the interference-suppression disk is not durably reliable, for example because it can be impaired by corrosion.

The object underlying the present invention is therefore to provide a long-lived, reliable, interference-suppressed commutator of the class in question, which commutator can be produced at low costs with little manufacturing expense, and wherein it is intended particularly preferably to make it possible to manufacture an interference-suppressed commutator with substantially the same dimensions as a non-interference-suppressed commutator of the same design.

This object is achieved according to the present invention by the fact that the conductor segments are provided in the region of the ends opposite the terminal lugs with resilient contact tabs in the form of substantially axial fingers which, at a distance from their root points, are each connected directly and in fixed manner to the interference-suppression disk at associated contact points, while the resilient contact tabs, in the region between their root point and their contact point, are each separated from the adjacent components of the drum commutator in such a way that, in this region, the position of the contact tabs relative to that of these respective adjacent components of the commutator can vary as a function of thermal expansion. A first characteristic feature of the drum commutator according to the present invention is therefore that contact tabs, which are integral constituents of the conductor segments, or in other words are made in one piece with the further regions of the conductor segments, are used for direct and immediate contacting of the conductor segments with the interference-suppression disk; thus the drum commutator according to the present invention does not have separate, additional components for contacting the conductor segments with the interference-suppression disk, as are provided according to the prior art, especially in the form of wires and leaf springs. The direct and immediate contacting between the contact tabs formed integrally on the conductor segments and the interference-suppression disk without having disadvantageous effects on the useful life of the commutator is then enabled by the fact that the contact tabs can deform to compensate for different thermal expansion behavior of the interference-suppression disk on the one hand and of the other commutator components on the other hand. The deformability of the contact tabs is in turn achieved on the one hand from their resilient design, wherein the contact points at which the contact tongues are joined directly and in fixed manner to the interference-suppression disk are disposed at a distance from the root points of the contact tabs, at which these merge in the sense of a static restraint into the adjoining region of the conductor segments, and on the other hand from the separation of the contact tabs relative to the adjacent components, so that the said components do not hinder unrestricted compensation for expansion. In particular, in this sense, the resilient contact tabs in the inventive drum commutator are separated at their radial inner faces from the adjacent component disposed radially inward of the contact tabs in such a way that their distance to the component in question can be varied as a function of thermal expansion. By that separation of the resilient contact tabs from the component of the commutator disposed in radially inward adjacent position, the contact tabs, depending on the respective thermal expansion of the individual components, can maintain a more or less large radial distance from the components adjoining them in radially inward direction. Because of the deformability of the contact tabs, the stresses that act in the region of the fixed connection of the contact tabs to the interference-suppression elements are reduced so much that damage to this connection is excluded. The contact tabs can therefore be connected permanently to the interference-suppression disk, especially by means of simple soldered joints or even joints formed with electrically conductive adhesive in the region of the contact points.

In application of the present invention, it is therefore obviously possible, by virtue of the combinations of the features characteristic of inventive drum commutators, to manufacture extremely inexpensive, long-lived and compact interference-suppressed commutators with minimum production expense, using a minimum number of components.

A first preferred improvement of the drum commutator according to the present invention is characterized in that the radial thickness of the resilient contact tabs is smaller than the thickness of the conductor segments. Not only does this favor the resilient compliance of the contact tabs as explained in the foregoing, but also, as will be immediately obvious from the explanations hereinafter, such a structure of the contact tabs proves to be particularly favorable in regard to minimizing the dimensions of the interference-suppressed commutator according to the present invention.

The reduced thickness of the contact tabs compared with the conductor segments is achieved particularly preferably by the fact that the radial outer surface of the resilient contact tabs is offset inward compared with the brush running surface. At the same time, the width of the resilient contact tabs as determined in circumferential direction is particularly preferably smaller than the width of the conductor segments; and the conductor segments are provided adjacent to the contact tabs with one or—particularly preferably—two axial projections, which in turn are integral constituents of the conductor segments, wherein the radial outer surfaces of the axial projections are disposed in a prolongation of the brush running surface. Hereby it becomes possible, in a commutation system containing the inventive commutator, that the brushes bearing against the brush running surface of the commutator extend in axial direction at least partly into the region in which the resilient contact tabs are disposed, or in other words that the contact tabs overlap at least partly. By the fact that the radial outer surfaces of the resilient contact tabs are offset inwardly relative to the brush running surface, resilient contact tabs deformed radially outward due to corresponding thermal stresses cannot collide with the brushes; thus the brushes also do not hinder deformation of the contact tabs due to thermal stresses, although the brushes overlap the contact tabs in order to minimize the dimensions of the commutator. These axial projections of the conductor segments provided adjacent to the contact tabs enlarge the brush running surface, and this in turn is favorable as regards the possibilities of minimizing the dimensions of the inventive commutator, and especially as regards adapting to the dimensions of non-interference-suppressed commutators of the same design. The radial thickness of these said axial projections of the conductor segments is generally greater than the radial thickness of the resilient contact tabs.

According to another preferred improvement of the invention, it is provided that the resilient contact tabs radially surround the interference-suppression disk on the outside, the resilient contact tabs being separated at their radial inner surfaces from the interference-suppression disk or from a molding-compound jacket surrounding it, and in particular maintaining a radial distance from these components. Such a design of the inventive commutator satisfies extreme requirements on a short axial overall length. In contrast, according to another preferred improvement of the invention, it is intended for the case of inventive drum commutators that in particular have a small diameter that the interference-suppression disk be provided with bores disposed around the commutator axis, through which bores the contact tabs are guided. The contact points at which the resilient contact tabs are connected in fixed manner to the interference-suppression disk are then disposed on the outwardly directed end face of the interference-suppression disk; and the bores are dimensioned larger than the cross sections of the contact tabs by such a size that the deformation of the resilient contact tabs compensating for the difference in thermal expansion is not hindered by the bores.

If the contact tabs radially surround the interference-suppression disk on the outside within the meaning of the first of the two improvements explained in the foregoing, the resilient contact tabs are particularly preferably curved in hook-like manner and bear against the outwardly directed end face of the interference-suppression disk. Particularly preferably, these resilient contact tabs maintain a distance to the outer edge of the end face of the interference-suppression disk in the region of their hook-like curvature and to a molding-compound jacket that may surround it. By virtue of corresponding deformation of the regions of the contact tabs having hook-like curvature, resilient contact tabs designed with such hook-like curvature favor compensation for possible expansions in axial direction due to different thermal stresses of the individual components and are also advantageous in terms of possible production tolerances. Alternatively, or in addition, the inwardly directed axial end face of the interference-suppression disk can maintain a distance to the support member in order to counteract damage to the commutator by corresponding axial thermal-expansion stresses.

However, the contacting of the contact tabs against the outwardly directed end face of the interference-suppression disk as explained in the foregoing is in no way compulsory. Within the scope of the present invention, contacting of the contact tabs against the circumferential face of the interference-suppression disk is similarly conceivable, as is contacting against its outer, outwardly directed end edge of the interference-suppression disk, or in other words in the transition region from the end face to the circumferential face.

Once again in a drum commutator having an interference-suppression disk disposed radially inward of the contact tabs, it is provided in yet another preferred improvement of the invention that the interference-suppression disk is surrounded at its outer circumferential face by a jacket of insulating molding compound, wherein the resilient contact tabs are respectively separated at their radial inner faces from the molding-compound jacket, and in particular maintain a radial distance to the molding-compound jacket. Analogously, a collar composed of insulating molding compound is preferably provided to bear against the inner circumferential face of the interference-suppression disk. Such embedding of the interference-suppression disk in insulating molding compound proves to be particularly favorable as regards a reliably long functional capability of the commutator, not the least because it is ruled out with certainty that rubbings of conductive material, especially rubbings of the brushes, can be deposited on non-exposed faces of the interference-suppression disk. Further, the molding-compound jacket in question as well as the molding-compound collar in question proves to be particularly favorable during mounting of the finished commutator on the rotor shaft of the electric machine in question, since the axial forces necessary for pressing the commutator onto the shaft can be transmitted into the support member via the collar and/or the jacket, whereby the danger or damage to or even destruction of the interference-suppression disk during mounting of the commutator is greatly reduced.

Within the scope of the present invention, it is possible to use different interference-suppression disks. In particular, varistor disks and condenser disks (known as multi-layer ceramic condensers) are suitable for use as interference-suppression disks for inventive drum commutators, although the present invention is not limited thereto.

According to yet another preferred improvement of the invention, it is intended that the interference-suppression disk be provided at its two end faces with metallization zones disposed opposite one another, which zones are respectively connected electrically conductively to one another in pairs via peripheral metallization zones. Such a design of the interference-suppression disk is particularly favorable as regards how it functions for the designed purpose, since hereby the interference-suppression characteristic can be positively influenced.

Preferably the support member of the inventive drum commutator is provided with pocket-like recesses adjacent to the connections of the contact tabs with the conductor segments. This favors manufacture of the commutator. In addition, the axial length available for deformation of the resilient contact tabs can be increased by corresponding pockets, and so the compliance of the contact tabs increases and thus internal stresses are limited to a relatively small extent.

As regards production of the inventive drum commutator, two possibilities are conceivable in principle for mounting of the interference-suppression disk. Firstly, the interference-suppression disk can be placed on the composite part comprising the support member and the conductor segments or a conductor blank comprising all conductor segments, and can be soldered to the contact tabs or connected thereto in another way (for example, by electrically conductive adhesive), especially after these—in the case of disposition of the interference-suppression disk radially inward of the contact tabs—have been bent over in hook-like manner; this means that the support member is first injection-molded onto the conductor blank before the interference-suppression disk is mounted and contacted, if necessary after segmentation of the conductor blank into the individual conductor segments. In this case, an annular slot in which the interference-suppression disk will be subsequently laid can be formed if necessary in the end face of the support member during manufacture. In this version of the method, it is entirely possible to mount the interference-suppression disk only after the commutator blank—which at this stage has not yet been completed—has been mounted on the rotor shaft; in this way, and depending on the conditions, selection and mounting of the interference-suppression disk could be left to the discretion of the manufacturer of the electric machine in which the inventive commutator is to be used. According to another particularly preferred version of the method, however, the interference-suppression disk is slipped onto the conductor blank before the support member is injection-molded onto the said blank, and if necessary is already contacted with the contact tabs; this version of the method ensures that the interference-suppression disk is embedded during manufacture of the support member in the molding compound used for manufacture thereof, in order to form the molding-compound jacket and/or molding-compound collar explained hereinabove.

As regards manufacture of the resilient contact tabs, different preferred production methods are available therefor, especially depending on the number of units to be produced. On the one hand, the conductor segments can be sawed from the end faces opposite the terminal lugs. Specifically, it is particularly preferable that two saw cuts be made in each conductor segment, so that a resilient contact tab is formed between each two saw cuts, while the axial projections explained in the foregoing are formed adjacent to the contact tabs, the said projections being able to extend the brush running surface of the commutator in question axially beyond the root region of the contact tabs. The reduced radial thickness of the subsequent resilient contact tabs is then expediently formed already during manufacture of the conductor blank and, in fact, independently of whether this is wound from a strip material or else is manufactured from a metal sheet by a deep-drawing press process or from a tubular portion by stamping. In the case of drum commutators that are manufactured in individual-segment design, or in other words without using a one-piece conductor blank comprising all conductor segments connected to one another by bridging parts, the reduced radial thickness of the subsequent resilient contact tabs is expediently already formed during manufacture of the blank for the individual conductor segments. From economic viewpoints, such manufacture of the resilient contact tabs by sawing the conductor segments at the end faces is to be preferred in particular for small numbers of units. In contrast, if large series of the inventive drum commutator are to be produced, it proves favorable to manufacture the resilient contact tabs by a shearing machine, which shears the starting material—and, particularly preferably, once again does so in two places in each case—on the end face of the conductor segments disposed opposite the terminal lugs, in order to manufacture the contact tabs by shearing a middle, narrow strip from the starting material together with the axial projections explained hereinabove on both sides next to this strip. Particularly preferably, two-stage shearing of the resilient contact tabs from the remaining material takes place as follows: in an initial step, the contact tabs are first sheared radially outward from the remaining material of the conductor segments, until they protrude obliquely outward; later, in a second step, and if necessary after the interference-suppression disk has been laid in place, the contact tabs are then forced radially inward, specifically beyond their original position. The width of the die to be used in these two steps is chosen such that, between the resilient contact tabs and the adjacent axial projections of the conductor segments, there is produced such a separation, expediently in the form of narrow gaps, that the deflection movement of the resilient contact tabs that is essential for the present invention is not hindered in radially outward direction. If hook-like bent-over structures are provided at all on the contact tabs at the end faces, they can be formed in particular during the second deformation step explained in the foregoing. Furthermore, it is to be pointed out that the two preferred versions of the method explained in the foregoing for manufacture of the resilient contact tabs can be employed regardless of whether or not the interference-suppression disk is embedded in the molding compound (see above).

The present invention will be explained in more detail hereinafter with reference to four preferred practical examples illustrated in the drawing, wherein

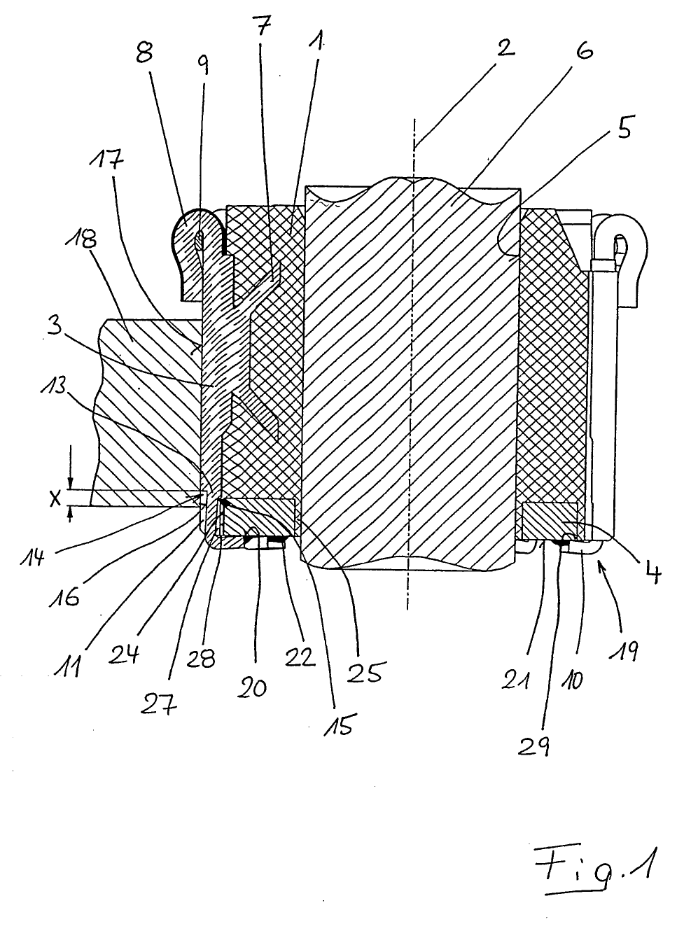

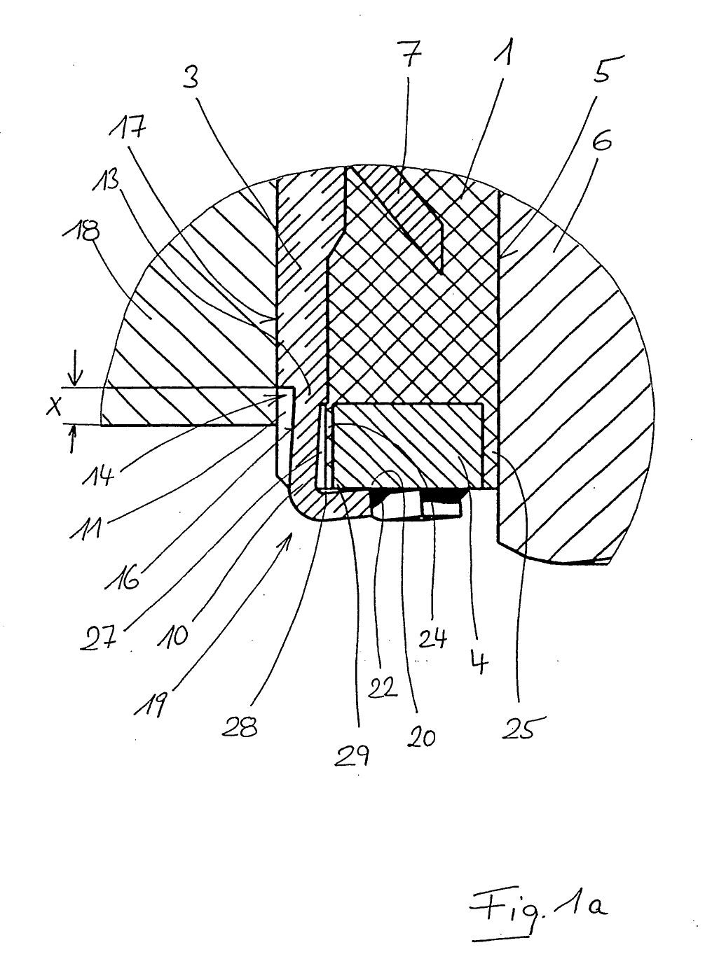

FIG. 1 shows an axial section through a first embodiment of a drum commutator according to the present invention,

FIG. 1a shows an enlarged detail of FIG. 1,

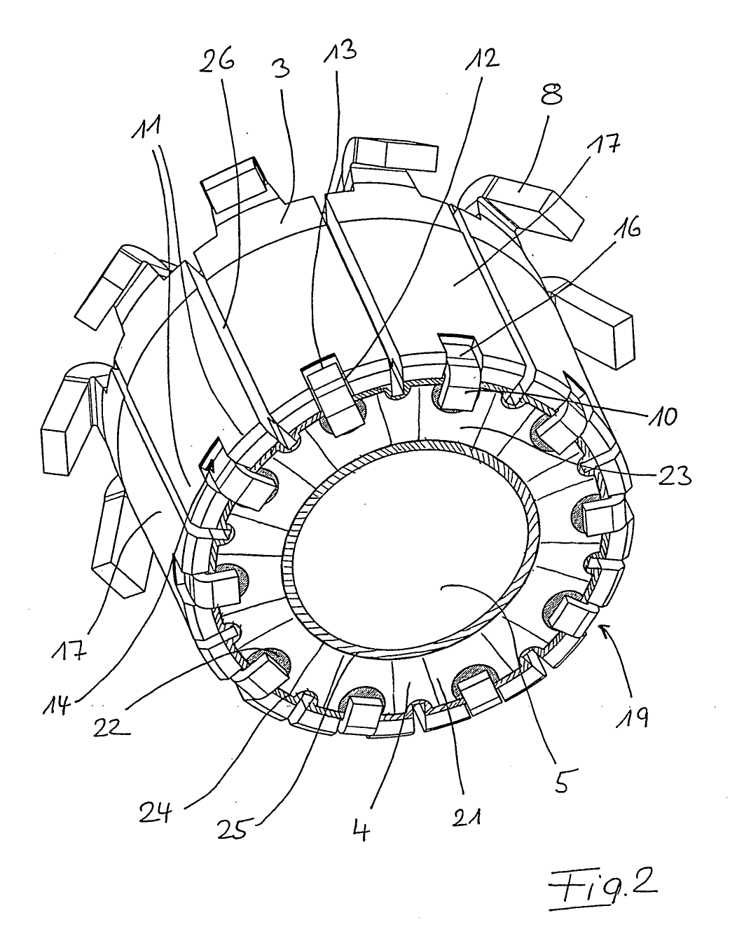

FIG. 2 shows a perspective view of the drum commutator according to FIG. 1,

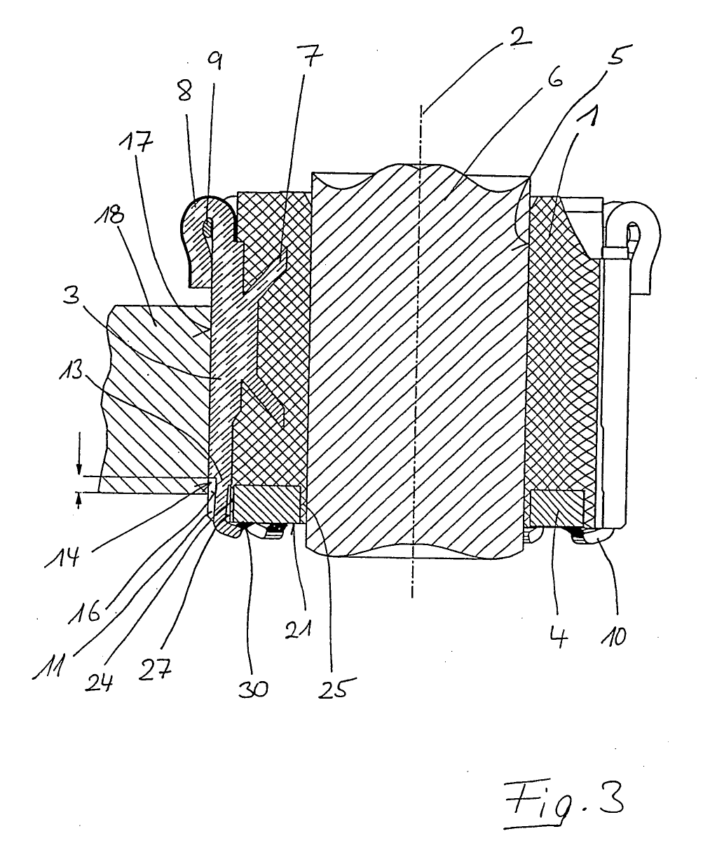

FIG. 3 shows an axial section through a second embodiment of a drum commutator according to the present invention,

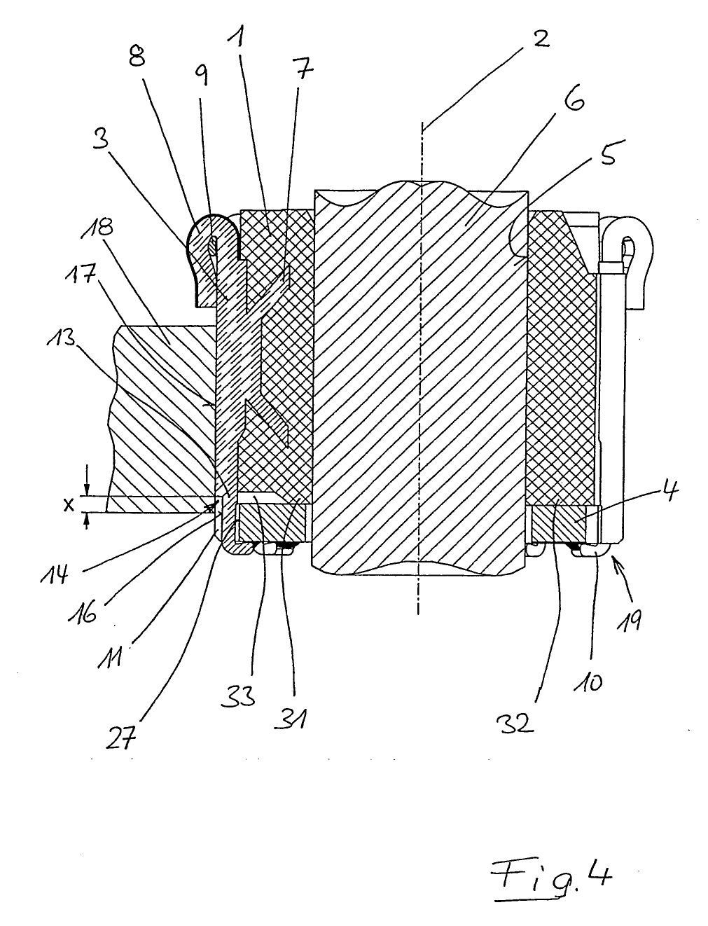

FIG. 4 shows an axial section through a third embodiment of a drum commutator according to the present invention,

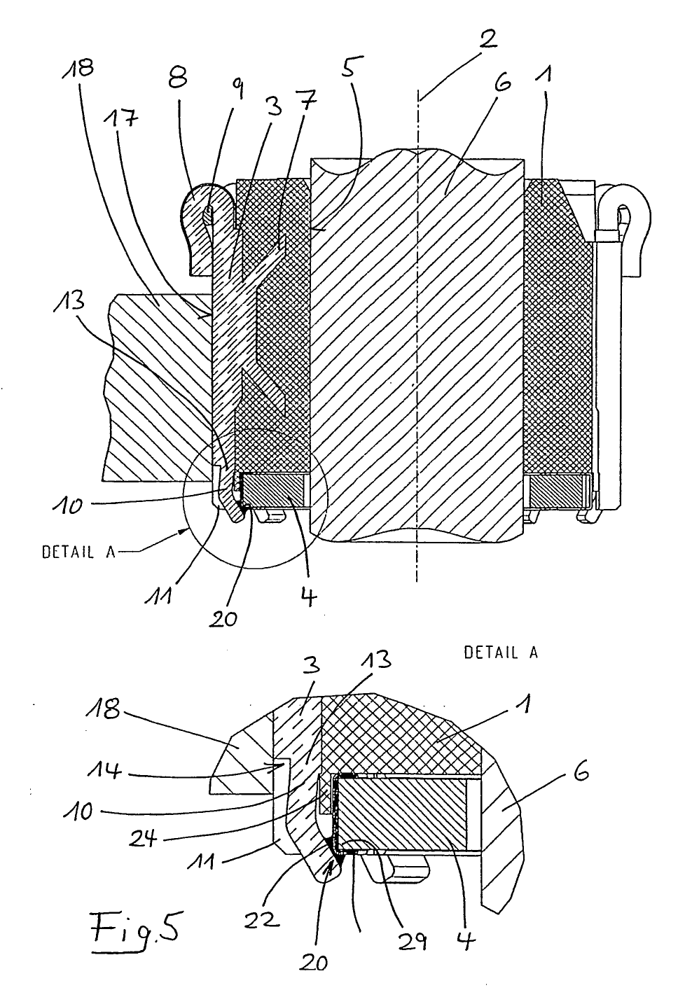

FIG. 5 shows an axial section through a fourth embodiment of a drum commutator according to the present invention and

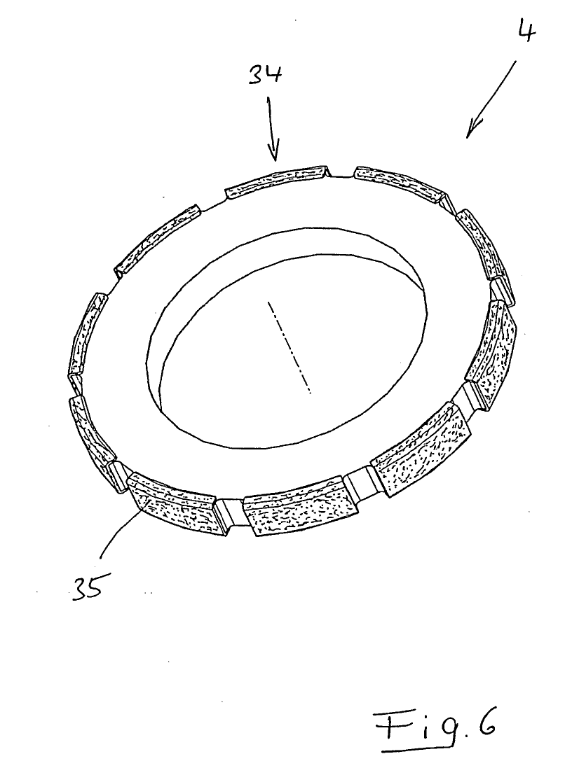

FIG. 6 shows a perspective view of the interference-suppression disk used to manufacture the drum commutator according to FIG. 5, which disk has the form of a condenser disk.

The drum commutator illustrated in FIGS. 1 and 2 contains as essential components a support member 1 made of insulating molding compound and ten conductor segments 3, which are disposed evenly around commutator axis 2, and an annular ceramic interference-suppression disk 4. Support member 1 is provided with a bore 5 concentric with axis 2 in order to mount the commutator on a rotor shaft 6.

Armature parts 7 of conductor segments 3 are embedded in the molding compound of support member 1 in order to anchor the conductor segments securely even at high speeds, despite the centripetal forces then occurring. At the ends of conductor segments 3 there are provided terminal lugs 8, which function in a manner known as such as the terminals of the winding wires 9 on the commutator.

On the end face of conductor segments 3 disposed opposite terminal lugs 8, resilient contact tabs 10 are molded onto these. On both sides of the contact tabs, each conductor segment 3 is provided with two axial projections 11, narrow gaps 12 being present between contact tabs 10 and the adjacent axial projections 11, so that the contact tabs, in order to avoid hindering their radial deflection movement, do not bear against projections 11. The radial thickness of contact tabs 10 is smaller than the radial thickness of projections 11 and of conductor segments 3 in their zones adjoining root region 13 of contact tabs 10. For this purpose, both radially outward as well as radially inward steps 14 and 15 are formed in root region 13 of the contact tabs; in other words, radial outer face 16 of resilient contact tabs 10 is offset inwardly relative to brush running surface 17 and the radial outer face of extensions 11 congruent therewith. This ensures that brushes 18 at least partly overlap contact tabs 10 by a distance X, in order to optimize the contact area, so that the radial outer face of projections 11 adjacent to contact tabs 10 is incorporated in the brush running surface.

Resilient contact tabs 10 are provided with hook-like bent-over structures 19 at the ends. The bending angle of these hook-like bent-over structures is distinctly larger than 90°, and so contact tabs 10 bear at their ends against corresponding contact points 20 on end face 21 of interference-suppression disk 4. A soldered connection 22 ensures permanent contact of contact tabs 10 with corresponding metallized zones 23 of interference-suppression disk 4.

Interference-suppression disk 4 is embedded in the molding compound of support member 1, specifically forming a molding-compound jacket 24 that externally surrounds interference-suppression disk 4 on the one hand and a molding-compound collar 25 that bears internally on interference-suppression disk 4 on the other hand. Saw cuts 26, by means of which the initially one-piece conductor blank is divided into individual conductor segments 3, extend into molding-compound jacket 24 in the region of projections 11, as is illustrated in particular in FIG. 2; thus only end face 21 of interference-suppression disk 4 is uncovered.

Following radially inward step 15 in root region 13 of contact tabs 10, as explained hereinabove, an air gap 27 exists between contact tabs 10 and molding-compound jacket 24. And the fact that the bent-over structure of contact tabs 10 explained hereinabove has an angle of greater than 90° leads to an axial clearance 28 between the contact tabs and the end face of molding-compound jacket 24 as well as outer end edge 29 of interference-suppression disk 4. Both are detail features that prove favorable as regards unhindered resilient compliance of contact tabs 10 for radial compensation of expansion. In addition, axial clearance 28 favors compensation for axial expansion as well as a tolerance compensation that is desirable from the production engineering viewpoint.

The embodiment of the inventive drum commutator illustrated in FIG. 3 corresponds in terms of its essential design features to the embodiment according to FIGS. 1 and 2. The only major difference is the different type of configuration of the contact tabs. In the drum commutator according to FIG. 3, these are bent inward only to a much smaller extent than 90°, and they do not bear against end face 21 of interference-suppression disk 4; instead, they maintain an axial distance to end face 21 of interference-suppression disk 4, which distance is spanned by a solder bridge 30. In this embodiment also, however, contact tabs 10 each maintain, for the reasons set forth hereinabove, a (radial) distance to the radial outer face as well as an (axial) distance to the axial end face of molding-compound jacket 24.

The drum commutator illustrated in FIG. 4 differs from that according to FIGS. 1 and 2 by the fact that, in particular, interference-suppression disk 4 in this case is not embedded in the molding compound of support member 1, but instead rests on the end face of support member 1, specifically in the region of an inner annular zone 31 on the one hand and radial stays 32 on the other hand. These radial stays 32 are disposed respectively between two conductor segments 3 adjacent to one another; and each stay 32 separates two pocket-like recesses 33 from one another, which recesses are respectively provided in the end face of support member 1, adjacent to root region 13 of contact tabs 10.

The fourth embodiment of the drum commutator according to the present invention, illustrated in FIG. 5, once again corresponds in terms of essential design features to the drum commutators according to FIGS. 1 to 4, as explained in the foregoing. In this case, however, interference-suppression disk 4 is designed not as a varistor disk but instead as a condenser disk in the form of a multi-layer ceramic condenser. As illustrated in FIG. 6, this disk does not have a circular outer circumferential face; instead it exhibits a number of radial projections 34 corresponding to the number of conductor segments, at the circumferential faces of which projections there is provided metallization 35 extending into the adjoining regions of the two end faces. In the region of those radial projections 34, resilient contact tabs 10 are connected to interference-suppression disk 4, in such a way that contact points 20 are disposed in the region of the outer, outwardly directed end edge 29 of interference-suppression disk 4.

In the case of the drum commutator according to FIGS. 5 and 6, and as regards the contacting of the interference-suppression disk explained hereinabove, molding-compound jacket 24 surrounding interference-suppression disk 4 extends over only part of the axial thickness thereof. An internal molding-compound collar is not provided at all.

Furthermore, there is obviously provided, in the region of root points 13 of contact tabs 10, a step to the respective adjoining region of associated conductor segment 3 that is much less pronounced than in the drum commutators explained hereinabove, and so contact tabs 10—regardless of their separation relative to molding-compound jacket 24—bear on the molding-compound jacket immediately adjacent to root points 13.

1. A drum commutator for an electric machine, comprising a sleeve-like support member (1) made from insulating molding compound, a plurality of metal conductor segments (3) disposed thereon in evenly spaced manner around the commutator axis (2), with terminal lugs (8) disposed thereon at the ends, and an annular interference-suppression disk (4), which is connected in electrically conductive manner to the conductor segments (3) in the region of the ends opposite the terminal lugs (8)
characterized in that
the conductor segments (3) are provided in the region of the ends opposite the terminal lugs (8) with resilient contact tabs (10) in the form of substantially axial fingers which, at a distance from their root points (13), are each connected directly and in fixed manner to the interference-suppression disk (4) at associated contact points (20), while the resilient contact tabs (10), in the region between their root point (13) and their contact point (20), are each separated from the adjacent components of the drum commutator in such a way that, in this region, the position of the contact tabs (10) relative to that of these respective adjacent components of the commutator can vary as a function of thermal expansion.

2. A drum commutator according to claim 1,
characterized in that
the radial thickness of the resilient contact tabs (10) is smaller than the radial thickness of the conductor segments (3) between the root point (13) of the contact tabs (10) and the terminal lugs (8).

3. A drum commutator according to claim 2,
characterized in that
the radial extent of the resilient contact tabs (10) lies within the radial extent of the conductor segments (3) between the root point (13) of the contact tabs (10) and the terminal lugs (8).

4. A drum commutator according to claim 1,
characterized in that
the radial outer surface (16) of the resilient contact tabs (10) is offset inward compared with the brush running surface (17).

5. A drum commutator according to claim 1,
characterized in that
the width of the resilient contact tabs (10) as determined in circumferential direction is smaller than the width of the conductor segments (3).

6. A drum commutator according to claim 5,
characterized in that
the conductor segments (3) are provided adjacent to the contact tabs (10) with axial projections (11), whose radial thickness is greater than the radial thickness of the contact tabs (10) and whose radial outer surfaces are disposed in a prolongation of the brush running surface (17).

7. A drum commutator according to claim 1,
characterized in that
the contact tabs (10) radially surround the interference-suppression disk (4) on the outside.

8. A drum commutator according to claim 7,
characterized in that
the contact tabs (10) are inwardly curved in hook-like manner at the ends and the contact points (20) are disposed on the outwardly directed end face (21) of the interference-suppression disk (4).

9. A drum commutator according to claim 8,
characterized in that
the contact tabs (10) maintain a distance to the outer edge (29) of the end face of the interference-suppression disk (4) in the region of their hook-like curvature.

10. A drum commutator according to claim 7,
characterized in that
the contact tabs (10) are bent back inwardly and the contact points (20) are disposed on the outwardly directed end edge (29) of the interference-suppression disk (4).

11. A drum commutator according to claim 7,
characterized in that
the contact points are disposed on the radially outer circumferential surface of the interference-suppression disk (4).

12. A drum commutator according to claim 1,
characterized in that
the interference-suppression disk is provided with bores disposed around the commutator axis (2), through which bores the contact tabs (10) are guided.

13. A drum commutator according to claim 1,
characterized in that
the interference-suppression disk (4) is surrounded at its outer circumferential surface, at least over part of its axial thickness, by a jacket (24) composed of insulating molding compound.

14. A drum commutator according to claim 1,
characterized in that
a collar (25) composed of insulating molding compound is provided to bear against the inner circumferential face of the interference-suppression disk (4).

15. A drum commutator according to claim 1,
characterized in that
the contact tabs (10) are soldered to the interference-suppression disk (4) in the region of the contact points (20).

16. A drum commutator according to claim 1,
characterized in that
the contact tabs (10) are bonded with electrically conductive adhesive to the interference-suppression disk (4) in the region of the contact points (20).

17. A drum commutator according to claim 1,
characterized in that
the interference-suppression disk (4) is provided at its two end faces with metallization zones (23) disposed opposite one another, which zones are respectively connected electrically conductively to one another in pairs via peripheral metallization zones.

18. A drum commutator according to claim 1,
characterized in that
the inwardly directed axial end face of the interference-suppression disk (4) maintains a distance to the support member (1).

19. A drum commutator according to claim 1,
characterized in that
the support member (1) is provided with pocket-like recesses (33) adjacent to the root points (13) of the contact tabs (10).

20. A commutation system containing a drum commutator according to claim 1 and at least two brushes (18) bearing on the brush running surface (17) of the conductor segments (3), wherein the brushes (18) protrude axially (X) beyond the root points (13) of the contact tabs (10).

21. A method for manufacture of a drum commutator according to claim 1, wherein the support member (1) is injection-molded onto a conductor blank comprising the entirety of the conductor segments (3) yet to be connected to one another and, in a subsequent step, the conductor blank is divided by cuts (26) into conductor segments (3) that are insulated from one another, the interference-suppression disk (4) being placed on the composite part comprising the support member (1) and the conductor segments (3) or the conductor blank and connected to the contact tabs (10).

22. A method according to claim 21,
characterized in that
an annular slot in which the interference-suppression disk (4) will be subsequently laid is formed during injection molding of the support member (1).

23. A method for manufacture of a drum commutator according to claim 1, wherein the support member (1) is injection-molded onto a conductor blank comprising the entirety of the conductor segments (3) yet to be connected to one another and, in a subsequent step, the conductor blank is divided by cuts (26) into conductor segments (3) that are insulated from one another, the interference-suppression disk (4) being slipped onto the conductor blank before the support member (1) is injection-molded onto the said blank and, during manufacture of the support member (1), is embedded in the molding compound used for manufacture of the support member, thus forming an outer molding-compound jacket (24) and/or an internal molding-compound collar (25).

24. A manufacturing method according to claim 21,
characterized in that,
for manufacture of the resilient contact tabs (10), two saw cuts are made in the conductor segments (3) from the end faces disposed opposite the terminal lugs (8), so that a resilient contact tab (10) is formed between each two saw cuts, while axial projections (11) are formed adjacent to the contact tabs (10).

25. A manufacturing method according to claim 21,
characterized in that,
for manufacture of the resilient contact tabs (10), each of the conductor segments (3) is sheared in two planes from the end faces disposed opposite the terminal lugs (8), in order to manufacture the contact tabs (10) by shearing a middle, narrow strip from the starting material together with axial projections (11) on both sides next to this strip.

26. A manufacturing method according to claim 25,
characterized by two-stage shearing of the resilient contact tabs (10) from the remaining material, in such a way that, in an initial step, the contact tabs (10) are first sheared radially outward from the remaining material of the conductor segments (3) and then, in a second step, they are bent back radially inwardly.

27. A manufacturing method according to claim 26,
characterized in that,
during the second step, the ends of the contact tabs (10) are bent back inwardly or are bent over in hook-like manner.

28. A manufacturing method according to claim 26,
characterized in that,
between the first and second stages of shearing of the contact tabs (10) from the starting material of the conductor segments (3), the support member (1) is molded onto the conductor blank.

29. A manufacturing method according to claim 26,
characterized in that,
between the first and second stages of shearing of the contact tabs (10) from the starting material of the conductor segments (3), the interference-suppression disk (4) is positioned on the conductor blank or on the support member (1) that may already be molded onto it.
